(19) United States
(12) Patent Application Publication
(10) Pub. No.: US 2010/0098551 A1
(43) Pub. Date: Apr. 22, 2010

(54) METHOD AND DEVICE FOR COATING COMPONENTS OF A GAS TURBINE

(75) Inventors: Herbert Hanrieder, Hohenkammer (DE); Alexander Gindorf, Schwabhausen (DE); Hans Pappert, Kufstein (AT)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/529,534

(22) PCT Filed: Feb. 28, 2008
(86) PCT No.: PCT/DE08/00353

§ 371 Date: Sep. 1, 2009

(30) Foreign Application Priority Data
Mar. 2, 2007 (DE) 10 2007 010 256.0

(51) Int. Cl. F01D 5/14; B05D 3/14; B05C 9/14

(52) U.S. Cl. 416/241 R; 427/591; 118/620

(57) ABSTRACT

The present invention relates to a method for coating components of a gas turbine, in particular for producing a wear-resistant, temperature, oxidation and/or corrosion-resistant protective coating on the component, wherein the protective coating is made of at least one solder film or slurry coating, which is connected to the corresponding region of the component by means of an inductive high-temperature soldering method. The bonded connection between the component and the solder film or slurry coating disposed on the component is achieved by locally heating the component in the region of the solder film or slurry coating to be applied, and simultaneously heating the solder film or slurry coating by means of thermal energy generated and emitted by at least one induction amplifier, wherein the induction amplifier is disposed between the inductor and the component in the region of the solder film or slurry coating. The invention further relates to a device for coating components of a gas turbine, in particular for producing a wear-resistant, temperature, oxidation and/or corrosion-resistant protective coating on the component, using at least one inductor for carrying out an inductive high-temperature soldering method for heating and bonding at least one component to at least one solder film or slurry coating forming the protective coating, wherein according to the invention at least one induction amplifier is disposed in the region of the solder film or slurry coating between the inductor and the component having the solder film or slurry coating.

This application claims the priority of International Application No. PCT/DE2008/000353, filed Feb. 28, 2008, and German Patent Document No. 10 2007 010 256.0, filed Mar. 2, 2007, the disclosures of which are expressly incorporated by reference herein.

### BACKGROUND AND SUMMARY OF THE INVENTION

The present invention relates to a method for coating components of a gas turbine, in particular for producing a wear-resistant, temperature, oxidation and/or corrosion-resistant protective coating on the component, wherein the protective coating is made of at least one solder film or slurry coating, which is connected to the corresponding region of the component by means of an inductive high-temperature soldering method. The invention further relates to a device for coating components of a gas turbine, in particular for producing a wear-resistant, temperature, oxidation and/or corrosion-resistant protective coating on the component, using at least one inductor for carrying out an inductive high-temperature soldering method for heating and bonding at least one component to at least one solder film or slurry coating forming the protective coating.

Wear-resistant, temperature, oxidation and corrosion-resistant coatings are known and used in particular in parts of turbine and engine parts, in particular of gas turbines in an aircraft engine. Protective coatings with abrasive surfaces or properties are known for example from U.S. Pat. Nos. 6,811,898 or 5,359,770. The protective coatings described there are used in particular for coating blade tips of a turbine, normally called blade tip armoring. A variety of other different methods are known to produce this type of blade tip armoring. Thus, German Patent Document No. DE-C2-4439950 describes a method for producing a blade tip armoring on a blade made of a titanium-based alloy. In this case, a solder is applied to the blades in layers, wherein the composition of the solder is adapted to the composition of the blades, namely the titanium-based alloy. Then hard material particles are applied to the blade coated with the solder and bonded to the solder in a subsequent fusing process. Furthermore, high-temperature soldering is also known as a furnace process for coating components of a gas turbine, wherein this method can no longer be used at temperatures above 1200° C. with so-called single-crystal blades, because there is a risk that the single-crystal blades will recrystallize and thereby lose their strength properties. In addition, a method for producing blade tip armoring is known in which the to-be-coated blades are induced and heated by means of an inductive local high-temperature soldering. A solder film or slurry coating having the desired protective coating properties is applied to the blade tips that are being coated. Because the solder film or slurry coating is not directly heated by the induction, the temperature must be transmitted by thermal conduction from the blades or blade tip to the solder film or slurry coating. However, this process is technically precarious because slight shifts or lifting of the solder film or slurry coating are possible, thereby impairing the connection of same to the component and overall the soldering result is inadequate. In addition, regulating the inductor's power is very involved procedurally.

As a result, the objective of the present invention is to provide a generic method for coating components of a gas turbine, in particular for producing a wear-resistant, temperature, oxidation and/or corrosion-resistant protective coating on the component, which guarantees a qualitatively high-grade, reliable and durable coating of the components, on the one hand, and simple process control and high production rates on the other.

It is further the objective of the present invention to provide a generic device for coating components of a gas turbine, in particular for producing a wear-resistant, temperature, oxidation and/or corrosion-resistant protective coating on the component, which guarantees a qualitatively high-grade, reliable and durable coating of the components, on the one hand, and simple process control and high production rates on the other.

### DETAILED DESCRIPTION OF THE INVENTION

An inventive method for coating components of a gas turbine, in particular for producing a wear-resistant, temperature, oxidation and/or corrosion-resistant protective coating on the component, wherein the protective coating is made of at least one solder film or slurry coating and is connected to the corresponding region of the component by means of an inductive high-temperature soldering method, is characterized according to the invention in that the bonded connection between the component and the solder film or slurry coating disposed on the component is achieved by locally heating the component in the region of the solder film or slurry coating to be applied, and simultaneously heating the solder film or slurry coating by means of thermal energy absorbed and emitted by at least one induction amplifier, wherein the induction amplifier is disposed between the inductor and the component in the region of the solder film or slurry coating. By using the induction amplifier within the inductor it is advantageously possible to influence and control the application of heat to the solder film or slurry coating in such a way that constant temperature conditions are maintained in the to-be-coated component and in the solder film or slurry coating. As a result, producing a qualitatively high-grade, reliable and durable coating of components of a gas turbine is guaranteed. In this case, the heating of the solder film or slurry coating can be carried out by the radiant heat emitted by the induction amplifier. However, it is also possible for the heating of the solder film or slurry coating to be carried out by direct coupling of the thermal energy generated in the induction amplifier.

In an advantageous embodiment of the inventive method, the induction amplifier is spaced apart from the solder film or slurry coating.

In addition, it is possible for the distance between the components having the solder film or slurry coating and the induction amplifier and/or the position of the component having the solder film or slurry coating within the inductor to be regulated or controlled in order to regulate the temperature in the to-be-coated region of the component and the solder film or slurry coating. As a result, it is possible to dispense with a separate regulation of power for the application of heat to the to-be-coated component and the solder film or slurry coating. According to the invention, the temperature of the to-be-coated component and the solder film or slurry coating is adjusted by the location of the component within the coil and the distance from the induction amplifier in such a way that optimum soldering conditions prevail. As a result, according to the invention, parallel operation of the coating process with several inductors is possible, wherein the inductors can be connected to a generator. According to a further embodiment of the inventive method, it is possible for a regulation of the temperature in the component and the solder film or slurry coating to be carried out by a suitable selection of the size of the induction amplifier. All in all, the advantageous result is a simplification of process control, because the temperature can no longer be adjusted via generator power, but via the position of the component within the inductor and/or via the distance of the component having the solder film or slurry coating from the induction amplifier and/or the suitable selection of the size of the induction amplifier. In serial operation these arrangements can be applied to several inductors in parallel in order to increase the efficiency of the coating process. The distance between the component having the solder film or slurry coating and the induction amplifier is normally 0.5 to 4.5 mm, preferably 1.0 to 3.0 mm.

In a further advantageous embodiment of the inventive method it is also possible for the regulation of the temperature in the component and the solder film or slurry coating to be carried out by means of regulating the power and/or the frequency of the inductor. In this case, the inductor may be operated at a frequency between 50 and 700 kHz, preferably 100 and 600 kHz. In some fields of application, this additional power regulation can be advantageous, even if it leads to more complex process control.

According to a further advantageous embodiment of the inventive method, the solder film or slurry coating is made of a solder, a binding agent and hard material particles. The solder in this case may be made of an eutectic solder, whose alloy has at least one base material of the component that is being coated. As a result, excellent compatibility of the solder with the base material of the to-be-coated component is advantageously guaranteed. Compatibility in this case relates in particular to the thermal coefficient of expansion of the component and the solder film or slurry coating or the protective coating as well as to the adhesive power of the solder on the component. The solder in this case can be made of a MCrAlY matrix or MCrAlXAE matrix with M=Fe, Co, Ni, NiCo or CoNi, X=Si, Ta, V, Nb, Pt, Pd and AE=Y, Ti, Hf, Zr, Yb. The hard material particles in this case may be made in particular of (cubic) boron nitride, ceramic, titanium carbide, tungsten carbide, chromium carbide, aluminum oxide or zirconium oxide or a mixture thereof. The binding agent of the solder film or slurry coating may be made of synthetic or other organic materials. Normally, the binding agent vaporizes during heating of the solder film or slurry coating and the corresponding bonding to the component. This results overall in a wear-resistant, temperature, oxidation and/or corrosion-resistant abrasive protective coating, which is suitable in particular for application to a blade tip of a turbine blade. The protective coating can have a thickness of 10 μm to 6.0 mm, in particular 30 μm to 300 μm. The hard material particles can have a particle size of 0.1 μm to 200 μm.

An inventive device for coating components of a gas turbine, in particular for producing a wear-resistant, temperature, oxidation and/or corrosion-resistant protective coating on the component has at least one inductor for carrying out an inductive high-temperature soldering method for heating and bonding at least one component to at least one solder film or slurry coating forming the protective coating. According to the invention, at least one induction amplifier is disposed in the region of the solder film or slurry coating between the inductor and the component having the solder film or slurry coating. As a result, it is advantageously possible to carry out simultaneous, local heating of the component in the region of the to-be-applied solder film or slurry coating, and heating of the solder film or slurry coating even by means of the thermal energy absorbed and emitted by the induction amplifier. Moreover, the application of heat to the solder film or slurry coating and the component can be influenced and controlled by means of the induction amplifier in such a way that constant temperature conditions are maintained in the to-be-coated component and in the solder film or slurry coating. The device is therefore suitable for producing a qualitatively high-grade, reliable and durable coating of components of a gas turbine. The heating of the solder film or slurry coating is carried out in this case by the radiant heat emitted by the induction amplifier and/or by a direct coupling of the thermal energy generated in the induction amplifier into the solder film or slurry coating.

In an advantageous embodiment of the inventive device, the induction amplifier is made of titanium, a titanium alloy, SiC or graphite. Other suitable materials are also conceivable. The induction amplifier may be embodied in this case to be solid. However, it is also possible for the induction amplifier to be embodied from a plurality of particles. In addition, the shape of the induction amplifier can be adapted at least partially to the shape of the region of the inductor facing the component. It is further possible for the shape of the induction amplifier at a region facing the component to correspond at least partially to the shape of the component in this region. Because of the described measures, the application of heat to the solder film or slurry coating as well as to the region of the component to be coated therewith is optimized, i.e., there is homogeneous heating of the corresponding regions.

Furthermore, the inductor can be embodied as double-wound coil. Other embodiments are also conceivable however.

In an further advantageous embodiment of the inventive device, the distance between the component having the solder film or slurry coating and the induction amplifier and/or the position of the component having the solder film or slurry coating within the inductor can be regulated or controlled by means of a control device in order to regulate the temperature in the to-be-coated region of the component and the solder film or slurry coating. The distance in this case may be 0.5 to 4.5 mm, preferably 1.0 to 3.0 mm. This results advantageously in a simplification of process control, because the temperature in the solder film or slurry coating and at the corresponding region of the component can no longer be adjusted via generator power, but via the position of the component within the inductor and/or via the distance of the component having the solder film or slurry coating from the induction amplifier. According to a further advantageous embodiment of the invention, it is thus possible for several inductors to be connected to respectively at least one induction amplifier having a generator. This allows the efficiency of the coating process to be increased considerably; the arrangements of the induction amplifier described in the foregoing can be used in parallel in serial operation on several inductors.

In another advantageous embodiment of the inventive device it is also possible for the device to have a regulating device for regulating the power and/or the frequency of the inductor. The inductor in this case may be operated at a frequency between 50 and 700 kHz, preferably 100 and 600 kHz. In some fields of application, this additional power regulation can be advantageous, even if it leads to more complex process control.

According to an advantageous embodiment of the device, the solder film or slurry coating is made of a solder, a binding agent and hard material particles.

In a further advantageous embodiment of the inventive device, the solder is made of an eutectic solder, whose alloy has at least one base material of the component that is to be coated. As a result, excellent compatibility of the solder with the base material of the component that is to be coated, as already described in the foregoing, is advantageously guaranteed. The solder in this case may be made of a MCrAlY matrix or MCrAlXAE matrix with M=Fe, Co, Ni, NiCo or CoNi, X=Si, Ta, V, Nb, Pt, Pd and AE=Y, Ti, Hf, Zr, Yb. The hard material particles may be made in particular of (cubic) boron nitride, ceramic, titanium carbide, tungsten carbide, chromium carbide or zirconium oxide or a mixture thereof.

The binding agent of the solder film or slurry coating may be made of synthetic or other organic materials, as already described in the foregoing.

The inventive device is suitable in particular for producing a blade tip armoring of a blade tip of a turbine blade. In particular, the component can be a blade tip of a turbine blade of a gas turbine of an aircraft engine.

The inventive method described in the foregoing and the inventive device described in the foregoing are used for applying a high-temperature, oxidation and corrosion-resistant protective coating on turbine and engine parts, in particular of gas turbines in an aircraft engine.

According to a further advantageous use of the inventive method described in the foregoing and the inventive device described in the foregoing, these may be used for improving a high-temperature, oxidation and corrosion-resistant protective coating of turbine and engine parts, in particular of gas turbines in an aircraft engine.

1-34. (canceled)

35. A method for coating a component of a gas turbine, in particular for producing a wear-resistant, temperature, oxidation and/or corrosion-resistant protective coating on the component, wherein the protective coating is made of a solder film or a slurry coating, comprising the steps of:
connecting the solder film or the slurry coating to a region of the component by:
locally heating the component in the region of the solder film or the slurry coating to be applied; and
simultaneously heating the solder film or the slurry coating by thermal energy absorbed and emitted by an induction amplifier, wherein the induction amplifier is disposed between an inductor and the component.

36. The method according to claim 35, wherein the step of heating the solder film or the slurry coating is carried out by radiant heat emitted by the induction amplifier.

37. The method according to claim 35, wherein the step of heating the solder film or the slurry coating is carried out by direct coupling of the thermal energy.

38. The method according to claim 35, wherein the induction amplifier is spaced apart from the solder film or the slurry coating.

39. The method according to claim 35, wherein a distance between the component and the induction amplifier and/or a position of the component within the inductor is regulated or controlled to regulate a temperature in the region of the component and the solder film or slurry coating.

40. The method according to claim 39, wherein the distance is 0.5 to 4.5 mm.

41. The method according to claim 35, further comprising the step of regulating a temperature in the component and the solder film or slurry coating by regulating a power and/or a frequency of the inductor.

42. The method according to claim 41, wherein the inductor is operated at a frequency between 50 and 700 kHz.

43. The method according to claim 35, further comprising the step of regulating a temperature in the component and the solder film or slurry coating by selecting a size of the induction amplifier.

44. The method according to claim 35, wherein the solder film or the slurry coating is made of a solder, a binding agent, and hard material particles.

45. The method according to claim 44, wherein the solder is made of an eutectic solder that has an alloy that includes a base material of the component.

46. The method according to claim 44, wherein the solder is made of a MCrAlY matrix or MCrAlXAE matrix with M=Fe, Co, Ni, NiCo or CoNi, X=Si, Ta, V, Nb, Pt, Pd and AE=Y, Ti, Hf, Zr, Yb.

47. The method according to claim 44, wherein the hard material particles are made of (cubic) boron nitride, ceramic, titanium carbide, tungsten carbide, chromium carbide, aluminum oxide or zirconium oxide or a mixture thereof.

48. The method according to claim 35, further comprising the step of parallel coating of several components by a respective inductor with an induction amplifier, wherein the respective inductors are connected to a generator.

49. The method according to claim 35, wherein the component is a blade tip of a turbine blade.

50. A device for coating a component of a gas turbine, in particular for producing a wear-resistant, temperature, oxidation and/or corrosion-resistant protective coating on the component, comprising:
an inductor, wherein the inductor heats and bonds the component to a solder film or a slurry coating forming the protective coating and wherein an induction amplifier is disposed between the inductor and the component.

51. The device according to claim 50, wherein the induction amplifier is made of titanium, a titanium alloy, SiC or graphite.

52. The device according to claim 50, wherein the induction amplifier is embodied to be solid.

53. The device according to claim 50, wherein a shape of the induction amplifier is adapted at least partially to a shape of a region of the inductor facing the component.

54. The device according to claim 50, wherein a shape of the induction amplifier at a region facing the component corresponds at least partially to a shape of the component in the region facing the component.

55. The device according to claim 50, wherein the inductor is embodied as a double-wound coil.

56. The device according to claim 50, wherein a distance between the component and the induction amplifier and/or a position of the component within the inductor is regulatable or controllable by a control device to regulate a temperature in a region of the component and the solder film or slurry coating.

57. The device according to claim 56, wherein the distance is 0.5 to 4.5 mm.

58. The device according to claim 50, further comprising a regulating device which regulates a power and/or a frequency of the inductor.

59. The device according to claim 50, wherein the inductor is operated at a frequency between 50 and 700 kHz.

60. The device according to claim 50, wherein the solder film or slurry coating is made of a solder, a binding agent, and hard material particles.

61. The device according to claim 60, wherein the solder is made of an eutectic solder that has an alloy that includes a base material of the component.

62. The device according to claim 60, wherein the solder is made of a MCrAlY matrix or MCrAlXAE matrix with M=Fe, Co, Ni, NiCo or CoNi, X=Si, Ta, V, Nb, Pt, Pd and AE=Y, Ti, Hf, Zr, Yb.

63. The device according to claim 60, wherein the hard material particles are made of (cubic) boron nitride, ceramic, titanium carbide, tungsten carbide, chromium carbide or zirconium oxide or a mixture thereof.

64. The device according to claim 50, further comprising several inductors connected to respective induction amplifiers having a generator.

65. The device according to claim 50, wherein the component is a blade tip of a turbine blade.

66. A component produced according to the method of claim 35, wherein the component is a blade tip of a turbine blade of a gas turbine of an aircraft engine.
